(19) United States
(12) Patent Application Publication
(10) Pub. No.: US 2014/0284894 A1
(43) Pub. Date: Sep. 25, 2014

(54) Transport System

(71) Applicant: Bernd Maciejewski, Markt Erlbach (DE)

(72) Inventor: Bernd Maciejewski, Markt Erlbach (DE)

(21) Appl. No.: 14/219,810

(22) Filed: Mar. 19, 2014

(30) Foreign Application Priority Data
Mar. 20, 2013 (DE) DE 102013204937.4

(51) Int. Cl. B62B 3/10

(52) U.S. Cl. CPC B62B 3/10
USPC 280/79.2

(57) ABSTRACT

A transport system for transporting at least one item of goods to be transported includes a base unit, at least one transportation unit for moving the transport system, and at least one transport goods area for accepting the at least one item of goods to be transported. The at least one transportation unit is surrounded on at least two different sides by the at least one transport goods area.

This application claims the benefit of DE 10 2013 204 937.4, filed on Mar. 20, 2013, which is hereby incorporated by reference in its entirety.

### BACKGROUND

The present embodiments relate to a transport system for transporting goods to be transported.

In the transport of goods (e.g., bulky items to be transported), the problem that may present itself is that the nature of the system used for transportation provides that the space basically available for the goods to be transported may be used only to a restricted extent.

The prior art includes four-way pallets that give the option of conveying the pallets from four sides. The goods to be transported are positioned on the carrying surfaces of the four-way pallets.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a system suitable for transporting goods, with a transport goods area tailored to a large stowage space for the goods, is provided.

One or more of the present embodiments use an optimized design of a stowage space available for the goods to be transported of a transport system, in that the transport goods area is tailored to the transportation unit of the transport system used.

A transport system for transporting at least one item of goods to be transported is provided. The transport system includes a base unit, at least one transportation unit for transportation of the transport system, and at least one transport goods area to accommodate the at least one item of goods to be transported. The at least one transportation unit is surrounded on at least two different sides by the at least one transport goods area.

On account of the construction of such a system, the space in the immediate vicinity of the transportation unit may be made directly usable, and thus the available space for the item of goods to be transported may be enlarged. The base unit may also be embodied partly in one piece with the at least one transportation unit. The base unit delimits the transport goods area in the direction of a weight force acting on the transport system.

In one embodiment, the height of the overall system may be optimized, since for many applications, it is less the overall volume and more the optimum distribution of the volume that is of importance. Thus, for example, by a reduction of an overall height of the inventive transport system, the restrictive boundary conditions of the transport path in the actual transport process (e.g., a door frame and/or a maximum load height of a truck) may be taken into account. This enables even bulky goods for transportation to be transported advantageously to a desired destination.

The transportation unit has at least one transportation device. In an advantageous embodiment, however, the transportation unit has at least two transportation devices. With a symmetrical arrangement of the transportation device to an axis of the system, a stable transportation of the goods to be transported may be achieved by two transportation devices.

In an embodiment, the transportation devices include areas to accept forks of a floor conveyor device. This enables the transport system to be advantageously moved with the aid of vehicles equipped with forks (e.g., with the aid of forklift trucks or pallet trucks).

In a further embodiment, the transport system includes at least one connecting unit for connecting the transportation device. Such connecting units may be support bars, tubes or struts. The connecting units stabilize the overall structure of the system. The connecting unit may, however, also be embodied in one piece with the transportation unit (e.g., the transportation device).

In one embodiment, the at least one connection unit includes a transverse strut. In this case, the transverse strut may be disposed approximately at right angles (e.g., 90±15°, 90±10°, or 90±5°) to a longitudinal extent of the transportation device. As an alternative, an arrangement of the transverse struts differing from the arrangement may also be provided (e.g., two transverse struts crossing over one another between the transportation devices). Such transverse struts further contribute to the stability of the overall system.

In one embodiment, the at least one connection unit at least partly includes a tray that is disposed between the transportation devices. As well as the stability-based character of the connection unit, a tray shape enables an additional protection of the goods to be transported to be achieved (e.g., against contamination through impurities from outside). Protection against contamination is also provided in another way (e.g., by fluid flowing out of the goods to be transported being caught by the tray and thus not being able to flow out into the environment). The connection with a tray further enables the optimum utilization of the available area for the goods to be transported.

In an embodiment, the transportation unit extends in a longitudinal direction of the transport system. In this case, the longitudinal direction is also the direction in which the goods to be transported are to be moved (e.g., the direction of travel of the system). A stability and/or an equilibrium of the transport system during transport with a floor conveyor device (e.g., a forklift truck or a pallet truck) may be advantageously achieved (e.g., when a longitudinal extent of the transport system is a multiple of a transverse extent of the transport system).

In a further embodiment, the transport system includes at least one second transportation unit having at least one transportation device that is embodied differently to a transportation device of the first transportation unit. Such a construction makes it possible, for example, to move the transport system in a second, different manner, so that in this way, a transport system able to be varied in usage may be provided. It is, however, also possible to use the at least one transportation device of the second transportation unit in addition to the first transportation unit for transportation purposes.

In one embodiment, the at least one transportation device of the second transportation unit includes roller elements that are embodied so that the roller elements may be turned and are able to move in different transport directions. Roller elements make an especially simple form of transportation that is independent of a further conveyor device possible (e.g., a floor conveyor device). This therefore also gives an advantage in narrow transport paths, since the overall structure (e.g., the overall length during transport) is greatly reduced. The embodiment able to be moved in different transport directions makes it easy to change the direction of travel (e.g., also a rapid change to the opposite direction of travel). The system may also be turned easily.

In an embodiment, the second transportation unit is embodied to be height-adjustable. This enables the second transportation unit to be withdrawn, for example, if the second transportation unit is not needed or enables the second transportation unit to react to the particular characteristics of the transport path. The height adjustability may be realized by eccentrics or push rods. Further units for height-adjustability of the second transportation unit appearing sensible to the person skilled in the art may also be provided.

In one or more of the present embodiments, the second transportation unit has at least two second transportation devices that are disposed in a transverse direction next to the first transportation unit and outside the transport goods area. With a symmetrical arrangement of the two second transportation devices in relation to an axis of the system, a further stable transportation of the transport goods may be achieved. Accommodating the device outside the transport goods area provides that a limitation of the transport goods area is prevented or avoided.

In one embodiment, the at least two second transportation devices are disposed on the base unit, for the primary transportation along the direction of travel of the system. A stable and low-wear arrangement of the at least two further transportation devices may thus be achieved. Arranging at least some of the second transportation devices on the first transportation unit, further units, and/or components of the transport system appearing as sensible to the person skilled in the art may also be provided.

In an advantageous embodiment, the base unit includes at least one protective unit. The transport goods area is covered by the protective unit at least partly in one base direction. Such protective units may be metal sheets, plates or rubber mats. The protective units protect the transport goods against contamination, for example, or possible contact with other obstacles located in the transport path. The base direction approximately refers to the direction of the weight force of the transport goods system. In one embodiment, the transport goods system is located for this purpose in an intended transport position. The transport goods area is separated from the floor by the base unit.

In one or more of the present embodiments, the transport system includes at least one wall unit for at least partly encasing the at least one transport goods area. Through this, the transport goods area and the transport goods are additionally protected in a least one further direction against contamination or other influences.

In one embodiment, the at least one wall unit has at least one positioning device. Such a positioning device includes a hook or eye, but also a damping device such as cushions or expanded foam. The positioning device provides that the transport goods are held securely and counteract possible shock hazards on the transport path, so that the transport goods may be advantageously protected against undesired damage while being transported with the transport system.

In a further embodiment, the first transportation unit includes at least one recess in a wall unit. This makes transportation of the transport system possible even with at least part encasing of the system (e.g., of the transport goods area).

In an embodiment, the transport system includes a support unit for supporting the at least one item of goods to be transported. Such a carrier unit may, for example, be formed by a central support that supports the transport goods towards different sides of the transport goods area and/or deflects forces acting on the transport goods. In such cases, the support unit may not be located in the middle of the transport system. The support unit may also be attached to one side or to a lateral area of the system.

In one embodiment. the support unit includes at least one attachment device for attaching the at least one item of goods to be transported. The item to be transported may be secured during transport via the support unit. These types of attachment devices may be formed from hooks, eyes or struts.

In one embodiment, the transport system includes a second connecting unit for stabilizing the support unit with the first transportation unit. Through this, a further stabilization of the transport system is achieved. Such connecting units may be formed from metal sheets (e.g., gusset plates or plates).

In one embodiment, the transport system includes a least one stabilization device for stabilizing the transport system. The stabilization device is attachable to the first transportation unit, to the base unit, and/or to the first connection unit. Through this, a weight balance of the transport system is achieved. Such a stabilization device may be formed from plates, metal sheets or rods.

In one or more of the present embodiments, the transport system includes at least one third connecting unit for further stabilization of the transport goods. The at least one third connecting unit connects the support unit to the first transportation unit and/or the base unit. The entire device is additionally stabilized by the direct connection of transportation unit and support unit. The support unit may also be directly connected to the base unit. Such connecting units may be formed from connecting bars, tubes or rods.

In one embodiment, the third connecting unit includes at least one second attachment device for attachment to the transport system. In this way, the transport goods may be easily and/or quickly released from the third connecting unit or may be connected to the unit again. Such attachment devices may be formed by quick-release fastenings such as star handles or other fastenings.

In one embodiment, the transport goods are a cladding part of a large technical device (e.g., a magnetic resonance device). Such cladding parts, because of the size of the large technical device of which they are part, are especially bulky and therefore use particular measures for their transport. During a replacement of the cladding parts, such as during an upgrade of the device, for example, transport of the cladding parts right up to the large device itself may be realized by the system of one or more of the present embodiments.

### BRIEF DESCRIPTION OF THE DRAWINGS

FIG. 1 shows a front view of a first exemplary embodiment of a transport system;

FIG. 2 shows a front view of a second exemplary embodiment of a transport system;

FIG. 3 shows a third exemplary embodiment of a transport system;

FIG. 4 shows a fourth exemplary embodiment of a transport system;

FIG. 5 shows a fifth exemplary embodiment of a transport system; and

FIG. 6 shows a sixth exemplary embodiment of a transport system.

### DETAILED DESCRIPTION

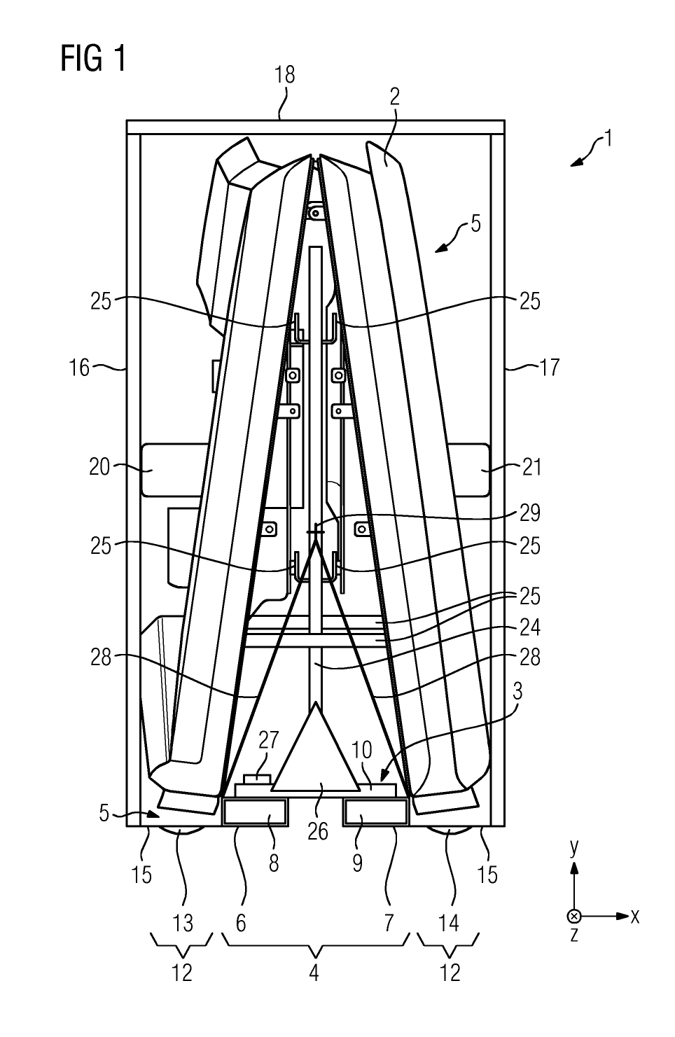

FIG. 1 shows a front view of one embodiment of a transport facility 1 (e.g., a transport system) for transporting at least one item to be transported 2. The transport system 1 includes a base unit 3, a first transportation unit 4 for transporting the transport system 1 and a transport goods area 5 for accepting at least one item to be transported 2. A division of the transport goods area into a number of subareas for accepting different transport goods may also be provided. At least the first transportation unit 4 is surrounded on two different sides by the one transport goods area 5.

The transport system 1 extends in an x direction, in a y direction and in a z direction. The z direction is aligned in parallel to a longitudinal direction of the transport system 1. The x direction is parallel to a transverse direction between the two transportation devices 6, 7 of the transport system 1. The y direction is aligned in parallel to a direction from the transportation unit through the transport goods area to a wall unit closing off the transport goods area against a force of gravity acting on the transport system 1. The force of gravity acts in the negative y direction. The transport system 1 is thus moved within the x-z plane.

The transportation unit 4 of the transport system 1 shown in FIG. 1 further includes four transportation devices 6, 7. The four transportation devices 6, 7 include four receiving areas 8, 9 for receiving forks of a floor conveyor device. In the front view depicted, only two transportation devices 6, 7 and two receiving areas 8, 9 are shown. The embodiment on the rear side is designed in a similar manner. This enables the transport system 1 to be transported with aid of vehicles equipped with forks (e.g., by forklift trucks or pallet trucks). The transport system 1 further includes a connecting unit 10 that is further configured for connecting the transportation devices 6, 7. The connecting unit 10 may, for example, be a support bar, a tube or a strut. The transportation unit 4 extends in the longitudinal direction z of the transport system 1.

The transport system 1 further includes a second transportation unit 12 that again has four transportation devices 13, 14. The four transportation devices 13, 14 are embodied differently to the transportation devices 6, 7 of the first transportation unit 4. In the front view shown in FIG. 1, only two second transportation devices 13, 14 are shown. The embodiment on the rear side is designed in a similar manner. In the example shown, the transportation devices are embodied as rolling elements. The rolling elements are rotatable and able to be moved in different transport directions x, z.

The rolling elements are further embodied to be height-adjustable. A height may be adjusted in the y direction by an operator. The height-adjustability may be realized by eccentrics or push rods, for example. The four second transportation devices 13, 14 are arranged in the transverse direction x alongside the first transportation unit 4 (e.g., alongside the first transportation devices 6, 7 and outside the transport goods area 5 on the base unit 3). Two of the second transportation devices 13, 14 are arranged in the z direction in a front area of the transport system 1, and two of the second transportation devices 13, 14 are arranged in the z direction in an end area of the transport system 1.

The base unit 3 further includes two protection units 15. The transport goods area 5 is covered by the protection units 15 at least partly in the base direction. The negative y direction in the direction of the gravitational force acts on the transport system 1. The protection units 15 protect the goods to be transported 2 against contamination or possible contact with other obstacles located on the transport path, for example.

The transport system 1 includes a number of wall units 16, 17, 18, that enclose the transport goods area 5. FIG. 1 shows the transport system 1 with the wall units taken off in the z direction. The wall units 16, 17, 18 may also be used during the actual utilization of the transport system 1. The wall units 16, 17, 18 may be able to be taken off for loading and unloading the transport goods 2. One or more of the wall units 16, 17, 18 include positioning devices 20, 21 that are configured to firmly hold the transport goods 2 within the housing formed by the wall units 16, 17, 18. The positioning devices 20, 21 may be hooks or eyes, for example, but also damping devices, such as cushions or expanded foam.

At least two of the wall units 16, 17, 18 (e.g., the wall units 16, 17, 18 disposed on the front side and/or on the rear side of the transport system 1) have recesses 22, 23 that represent an opening for the first transportation unit. In this way, the transportation unit 4 may be used even with the wall units attached.

A support unit 24 of the transport system 1 shown serves to support the at least one item of goods to be transported 2. The support unit 24 may be a central support, for example, that supports the goods to be transported 2 on different sides of the transport goods area 5. In this case, the support unit 24 does not have to be located in the center of the transport system 1. The support unit 24 may also be attached on one side or to a lateral area of the system 1, for example, depending on the weight distribution of the item of goods to be transported 2, for setting a stable equilibrium. The support unit 24 shown includes attachment device 25 for attaching and/or securing the at least one item to be transported 2. These attachment devices 25 are hooks, eyes or struts, for example, with which the item to be transported 2 may be attached or secured to the support unit 24.

The transport system 1 also has a second connecting unit 26. The second connecting unit 26 is intended for a stabilization of the support unit 24 with the first transportation unit 4. The connecting unit 26 shown is embodied in the form of a gusset plate. The connecting unit 26 may, however, also be embodied by plates or struts, for example, with which a further stabilization of the transport system is achieved.

The transport system 1 includes a stabilization device 27 for stabilizing the transport system 1. The stabilization device 27 is disposed on the first connecting unit 10. The stabilization device 27 is intended for equalizing the weight of the transport system, for example. The stabilization device 27 may, however, in an alternate embodiment of the transport system 1, also be attached to the first transportation unit 4 or to the base unit 3 and include plates, metal sheets, bars, tubes or other mass elements.

The transport system 1 also includes a third connecting unit 28 that contributes to further stabilization of the item of goods to be transported 2. The third connecting unit 28 connects the support unit 24 to the first transportation unit 4. The third connecting unit 28 may include connecting bars, tubes or struts, for example. In addition, the third connecting unit 28 may also be embodied to connect the support unit 24 to the base unit 3. The third connecting unit 28 further includes a second attachment device 29 for attachment to the transport system 1. The second attachment device 29 may include quick-release fasteners such as star handles, for example, or other fasteners with which the item of goods to be transported may be released from or connected to the third connecting unit 28 easily and/or quickly.

The item of goods to be transported 2 includes a cladding part of a magnetic resonance device.

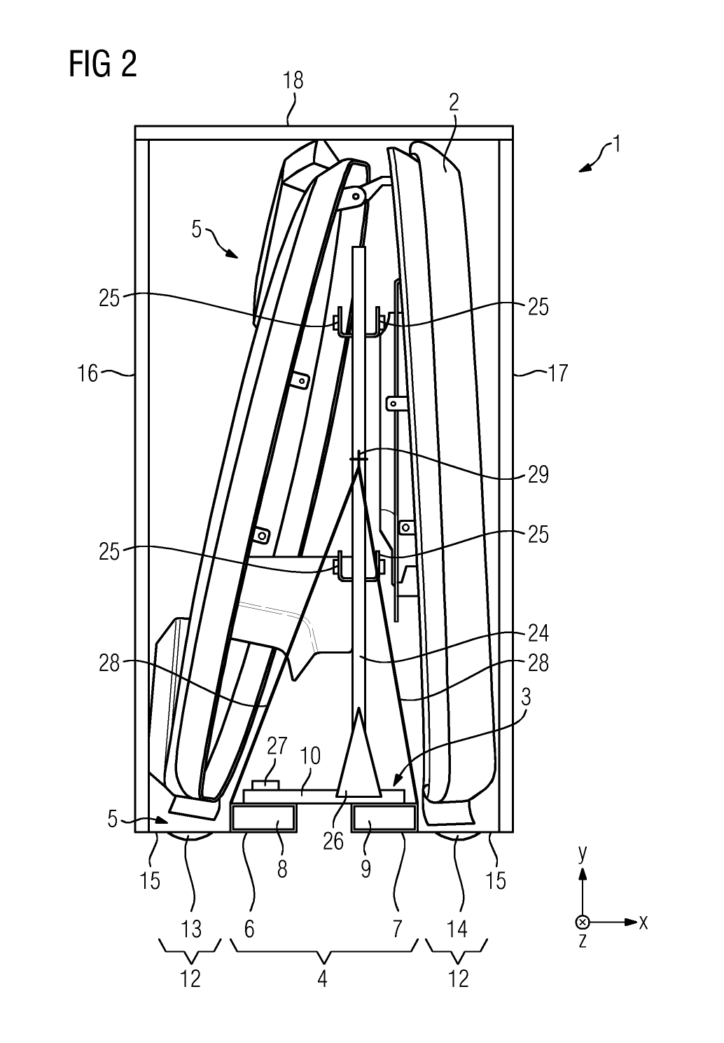

FIGS. 2-6 show alternate exemplary embodiments of a transport system. Components, features and functions that essentially remain the same are labeled with the same reference characters. The descriptions below are essentially restricted to the differences from the exemplary embodiment in FIG. 1, where the reader is referred to the description of the exemplary embodiment in FIG. 1 with regard to components, features and functions that remain the same.

FIG. 2 shows a second exemplary embodiment of a transport system 1 in a front view. Unlike the transport system 1 shown in FIG. 1, a number of hooks merely serve as attachment devices 25.

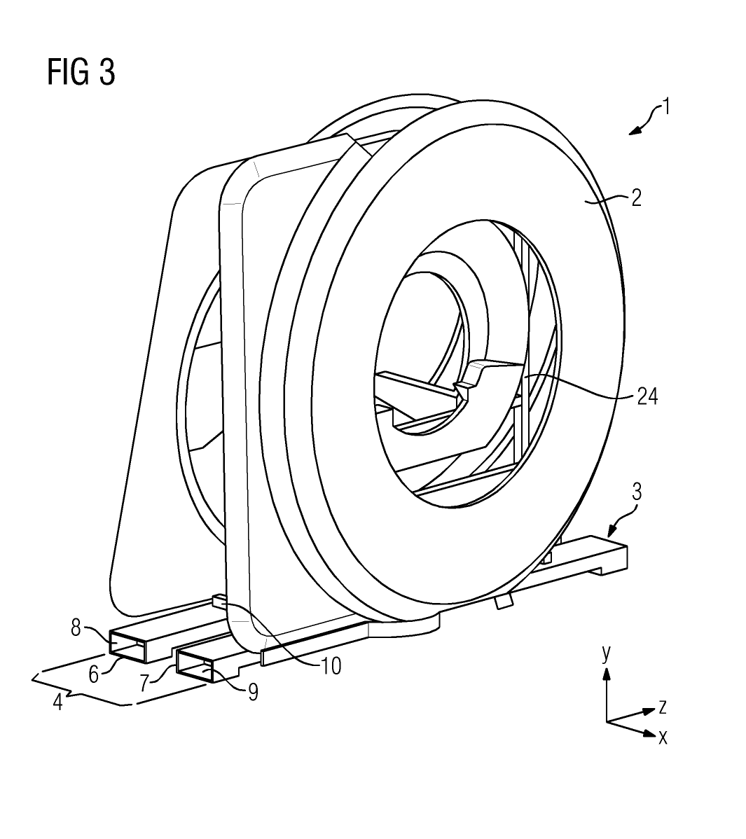

FIG. 3 shows a third exemplary embodiment of a transport system 1. The longitudinal extent of the transportation unit 4 of the transport system 1 is shown. For clarity, the figure does not show the second transportation unit 12, the second transportation devices 13, 14, the wall units 16, 17, 18, 19, the second connecting unit 26, the stabilization device 27, the third connecting unit 28, and the second attachment device 29.

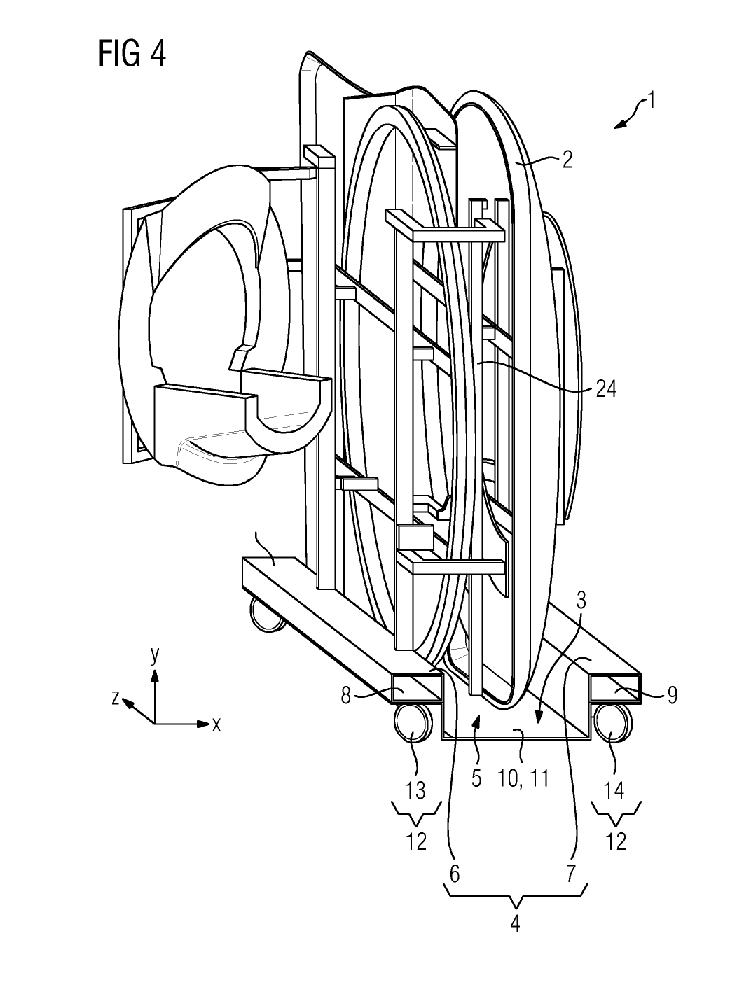

FIG. 4 shows a fourth exemplary embodiment of a transport system 1. The connecting unit 10 of the transport system 1 includes a tray 11 that is disposed between the transportation devices 6, 7. Accordingly, the transport goods area 5 also extends over the area enclosed by the tray (e.g., between the first transportation devices and the second transportation devices). A tree-shaped, branched structure of the support unit 24 that is tailored to the item of goods to be transported 2 and optimizes retention of the item of goods to be transported 2 is shown. Transverse struts of the support unit 24 are attached by a universal joint to the support unit 24. This provides that the item of goods to be transported 2 may be loaded and unloaded easily.

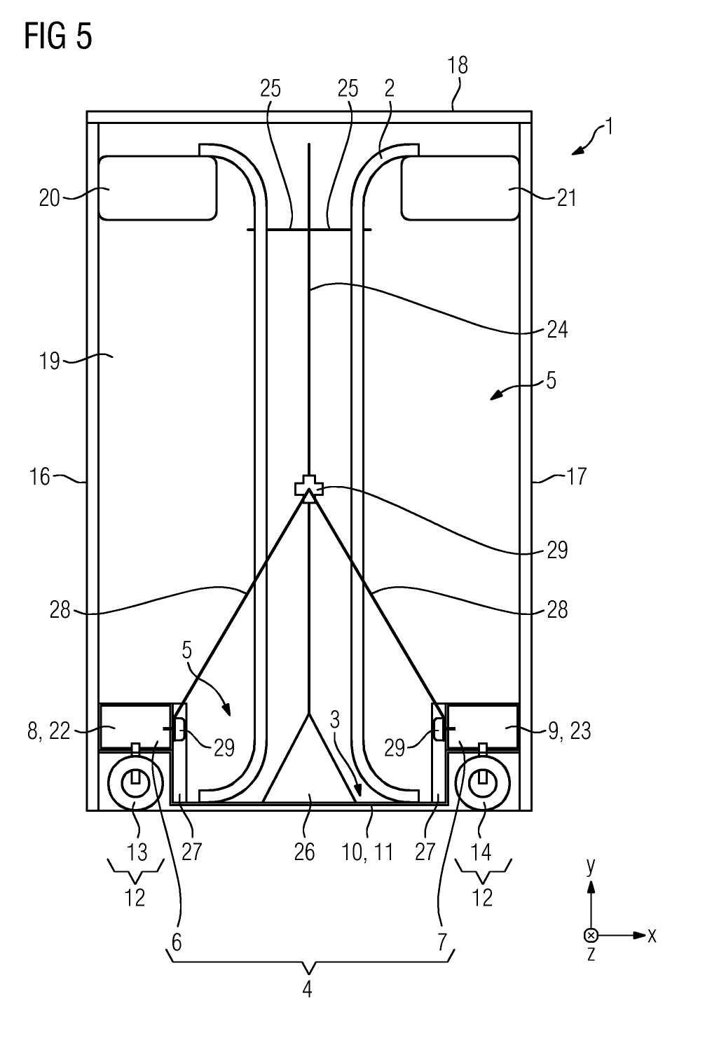

FIG. 5 shows a fifth exemplary embodiment of a transport system 1. The figure shows a cross-section in the x-y plane. Also visible is a rear wall unit 19. The connecting unit 10 of the transport system 1 also includes a tray 11 that is disposed between the transportation devices 6, 7. Support struts made of wood serve as a stabilization device 27. The stabilization device 27 may also include plates, steel sheets, rods, tubes or other mass bodies. Three quick-release fastenings are fitted as a second attachment device 29. The actual item of goods to be transported 2 is only shown schematically.

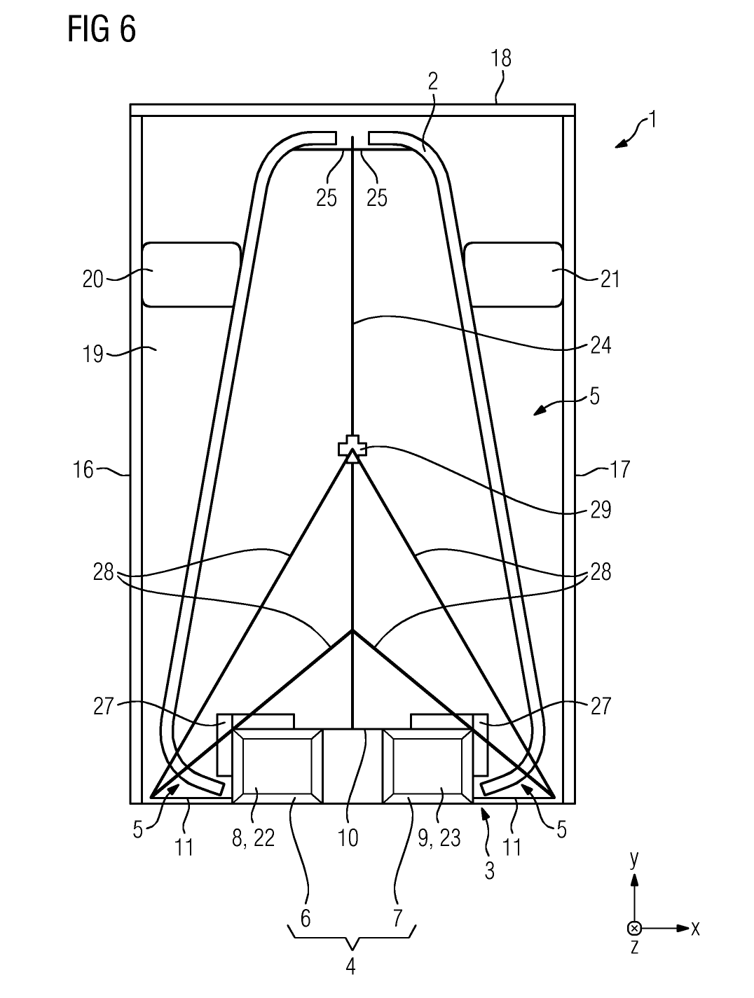

FIG. 6 shows a sixth exemplary embodiment of a transport system 1. The transport goods area 5 is predetermined by using a number of tray elements 11 that are connected together with support struts made of wood as the stabilization device 27. However, the stabilization device 27 may also include plates, steel sheets, rods, tubes or other mass bodies.

Although the invention has been illustrated and described in greater detail by the exemplary embodiments, the invention is not restricted by the disclosed examples. Other variations may be derived therefrom by the person skilled in the art without departing from the scope of protection of the invention.

One or more of the present embodiments relate to a transport system for transporting at least one item of goods to be transported. The transport system includes a base unit, at least one transportation unit for transporting the transport system and at least one transport goods area for accepting the at least one item of goods to be transported. The at least one transportation unit is surrounded on at least two different sides by the at least one transport goods area. In one embodiment, the transport system further includes a protection unit, a number of wall units and a number of connecting units. The transportation unit further includes at least two transportation devices. The transportation devices include areas to accept forks of a floor conveyor device. The item of goods to be transported is a cladding part of a large technical device.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A transport system for transporting an item of goods to be transported, the transport system comprising:
a base unit;
a transportation unit operable for transporting the transport system; and
a transport goods area for accepting the item of goods to be transported,
wherein the transportation unit is surrounded on at least two different sides by the transport goods area.

2. The transport system of claim 1, wherein the transportation unit comprises at least two transportation devices.

3. The transport system of claim 2, wherein a transportation device of the at least two transportation devices includes areas for accepting forks of a floor conveying device.

4. The transport system of claim 2, further comprising a connecting unit connecting the transportation devices.

5. The transport system of claim 4, wherein the connecting unit includes a transverse strut.

6. The transport system of claim 4, wherein the connecting unit comprises a tray that is disposed between the transportation devices.

7. The transport system of claim 1, wherein the transportation unit extends in a longitudinal direction of the transport system.

8. The transport system of claim 1, wherein the transportation unit is a first transportation unit, and
wherein the transport system further comprises a second transportation unit, the second transportation unit comprising at least one transportation device configured differently than a transportation device of the first transportation unit.

9. The transport system of claim 8, wherein the at least one transportation device of the second transportation unit includes rolling elements that are rotatable and movable in different transport directions.

10. The transport system of claim 8, wherein the second transportation unit is height-adjustable.

11. The transport system of claim 8, wherein the second transportation unit comprises at least two further transportation devices that are disposed in a transverse direction alongside the first transportation unit and outside the transport goods area.

12. The transport system of claim 11, wherein the at least two further transportation are disposed on the base unit.

13. The transport system of claim 1, wherein the base unit includes a least one protective unit, and
wherein the transport goods area is covered by the protective unit at least partly in one base direction.

14. The transport system of claim 1, further comprising at least one wall unit for at least partly encasing the transport goods area.

15. The transport system of claim 14, wherein the at least one wall unit comprises at least one positioning device.

16. The transport system of claim 14, wherein the first transportation unit includes at least one recess in a wall unit.

17. The transport system of claim 1, further comprising a support unit supporting the at least one item of goods to be transported.

18. The transport system of claim 17, wherein the support unit includes a least one attachment device operable to attach the at least one item of goods to be transported.

19. The transport system of claim 17, further comprising a connecting unit operable to stabilize the support unit with the first transportation unit.

20. The transport system of claim 4, further comprising a stabilization device operable to stabilize the transport system,
wherein the stabilization device is attachable to the first transportation unit, to the base unit, to the first connecting unit, or a combination thereof.

21. The transport system of claim 17, further comprising a connecting unit operable for stabilization of the item of goods to be transported,
wherein the connecting unit connects the support unit to the transportation unit, the base unit, or the transportation unit and the base unit.

22. The transport system of claim 21, wherein the connecting unit includes an attachment device operable for attaching to the transport system.

23. The transport system of claim 1, wherein the item of goods tube transported is a cladding part of a large technical device.

24. The transport system of claim 23, wherein the large technical device comprises a magnetic resonance device.
